(19) United States
(12) Patent Application Publication
(10) Pub. No.: US 2026/0019476 A1
(43) Pub. Date: Jan. 15, 2026

(54) WIRELESS COMMUNICATION METHOD AND RELATED APPARATUS

(71) Applicant: Huawei Technologies Co., Ltd., Shenznen (CN)

(72) Inventors: Sara Norouzi, Vancouver (CA); Jung Hoon Suh, Ottawa (CA); Yan Xin, Ottawa (CA); Osama Aboul-Magd, Ottawa (CA); Mahmoud Hasabelnaby, Ottawa (CA)

(21) Appl. No.: 18/890,545

(22) Filed: Sep. 19, 2024

Related U.S. Application Data
(60) Provisional application No. 63/669,075, filed on Jul. 9, 2024.

(51) Int. Cl. H04L 69/22

(52) U.S. Cl. CPC H04L 69/22; H04L 2212/00

(57) ABSTRACT

Provided are a wireless communication method and related apparatus. The wireless packet can be transmitted with a frame format including multiple constituent PSDUs. Each of the multiple constituent PSDUs comprises a PSDU. A control portion for the PSDU is used for reception and decoding of the PSDU.

### CROSS-REFERENCE TO RELATED APPLICATION

This application claims priority to U.S. provisional patent application No. 63/669,075, filed on Jul. 9, 2024, which is hereby incorporated by reference in its entirety.

### TECHNICAL FIELD

The present disclosure relates to the field of technologies of communication, and in particular, to a wireless communication method and related apparatus.

### BACKGROUND

The wireless local area network (WLAN) technology has evolved from the 802.11a/b/g, 802.11n, 802.11ac, and 802.11ax standards to the 802.11be standard. This comes with continuous increase of data throughput. From this perspective, the 802.11ax standard is also referred to as the high efficiency (HE) wireless standard, and the 802.11be standard is also referred to as the extremely high throughput (EHT) wireless standard.

A physical layer protocol data unit (PHY Protocol Data Unit, PPDU) is a frame format widely used in a WLAN system, and may be used for data transmission between WLAN nodes such as an access point (AP) and a terminal device (STA).

This background information is provided to reveal information believed by the applicant to be of possible relevance to the present disclosure. No admission is necessarily intended, nor should be construed, that any of the preceding information constitutes prior art against the present disclosure.

### SUMMARY

In a first aspect, an embodiment of the present disclosure provides a wireless communication method, comprising:
transmitting a wireless packet, wherein the wireless packet comprises a PHY (physical layer) header and a payload portion, wherein the payload portion comprises multiple constituent physical service data units (PSDU), and each of the multiple constituent PSDUs comprises a PSDU and a control portion for the PSDU used for reception and decoding of the PSDU.

The wireless packet can be transmitted with a frame format including multiple constituent PSDUs, and each constituent PSDU has its control portion and PSDU, with this frame format, the transmission efficiency can be improved and the transmission design can be flexible.

In a possible implementation of the first aspect, the PHY header indicates that the payload portion comprises the multiple constituent PSDUs.

The PHY header may have a function of indicating aggregation of multiple PPDUs (A-PPDU). The processing for A-PPDU may be different from that for a regular PPDU, e.g., the overhead for processing the A-PPDU may be higher than that of the regular PPDU. Hence, in this way, resources can be reasonably scheduled and utilized.

In a possible implementation of the first aspect, the PHY header comprises a U-SIG field indicating that the payload portion comprises the multiple constituent PSDUs.

In a possible implementation of the first aspect, a control portion in a leading constituent PSDU of the multiple constituent PSDUs indicates that the payload portion comprises the multiple constituent PSDUs.

The indication of aggregation of multiple PPDUs (A-PPDU) can also be implemented through the control portion in the leading constituent PSDU, which provides flexibility for applications. Besides, it is also possible to implement the indication of aggregation of multiple PPDUs by using the PHY header and the control portion in the leading constituent PSDU at the same time, i.e., more than one way to indicate the A-PPDU. On one hand, the reliability of this indication can be ensured, and on the other hand, there may be alternatives in case of one way is blocked.

In a possible implementation of the first aspect, the control portion in each of the multiple constituent PSDUs comprises a signal (SIG) field indicating whether the constituent PSDU is a last constituent PSDU of the payload portion.

In the case that a SIG field of a specific PSDU indicates this PSDU is the last constituent PSDU, no more preparation for data transmission is indicated.

In a possible implementation of the first aspect, for each of the multiple constituent PSDUs, the control portion in the constituent PSDU comprises receiver information indicating a destination of the PSDU in the constituent PSDU and decoding information for decoding the PSDU in the constituent PSDU.

Each constituent PSDU has its receiver information and decoding information, that is, the multiple constituent PSDUs can be independent, and in the case that a specific PSDU is missed or unable to decode, transmission of other PSDUs would not be affected.

In a possible implementation of the first aspect, for each of the multiple constituent PSDUs, the decoding information comprises a frame check sequence (FCS) for verifying decoding of the corresponding PSDU.

In the case that FCS indicates that decoding of a specific PSDU fails, this PSDU rather than all PSDUs may be requested to be retransmitted, so as to ensure all PSDUs are successfully transmitted with lower overhead.

In a possible implementation of the first aspect, for a leading constituent PSDU of the multiple constituent PSDUs, decoding information of the control portion in the leading constituent PSDU comprises:
auto gain control (AGC) information for a PSDU in the leading constituent PSDU;
channel estimation information used for decoding the PSDU in the leading constituent PSDU;
at least one signal parameter for decoding the PSDU in the leading constituent PSDU.

The above decoding information would be carried in the control portion of the leading constituent PSDU to ensure reliable data transmission.

In a possible implementation of the first aspect, the control portion in the leading constituent PSDU comprises a short training field (STF) indicating the AGC information for the PSDU in the leading constituent PSDU.

In a possible implementation of the first aspect, the control portion in the leading constituent PSDU comprises a long training field (LTF) indicating the channel estimation information for the PSDU in the leading constituent PSDU.

In a possible implementation of the first aspect, the control portion in the leading constituent PSDU comprises a signal (SIG) field indicating the at least one signal parameter for decoding the PSDU in the leading constituent PSDU.

In a possible implementation of the first aspect, the at least one signal parameter for decoding the PSDU in the leading constituent PSDU comprises at least one of following items:
a resource unit (RU) allocation of the PSDU in the leading constituent PSDU;
a modulation and coding scheme (MCS) of the PSDU in the leading constituent PSDU;
a number of spatial streams for the PSDU in the leading constituent PSDU.

In a possible implementation of the first aspect, for each of at least one constituent PSDU among the multiple constituent PSDUs other than the leading constituent PSDU, decoding information of the control portion in the constituent PSDU comprises at least one of following information:
AGC information for a PSDU in the constituent PSDU;
channel estimation information used for decoding the PSDU in the constituent PSDU;
at least one signal parameter for decoding the PSDU in the constituent PSDU.

For the constituent PSDU other than the leading constituent PSDU in the A-PPDU, it may be unnecessary to carry all the above decoding information in the control portion of the constituent PSDU, thus the overhead may be reduced in case that some information are omitted.

In a possible implementation of the first aspect, the control portion in the constituent PSDU comprises an STF indicating the AGC information for the PSDU in the constituent PSDU.

In a possible implementation of the first aspect, the control portion in the constituent PSDU comprises a LTF indicating the channel estimation information for the PSDU in the constituent PSDU.

In a possible implementation of the first aspect, the control portion in the constituent PSDU comprises a SIG indicating the at least one signal parameter for decoding the PSDU in the constituent PSDU.

In a possible implementation of the first aspect, the at least one signal parameter for decoding the PSDU in the constituent PSDU comprises at least one of following items:
an RU allocation for the PSDU in the constituent PSDU;
an MCS for the PSDU in the constituent PSDU;
a number of spatial streams for the PSDU in the constituent PSDU.

In a possible implementation of the first aspect, the PHY header indicates at least one of following information:
a number of constituent PSDUs in the A-PPDU;
a length of each of the multiple constituent PSDUs in the A-PPDU;
a length of the control portion for each PSDU in the A-PPDU.

In a possible implementation of the first aspect, PSDUs in the multiple constituent PSDUs are same PSDUs for a same set of users and coded with different signal parameters.

The PSDUs in the aggregation of PSDUs can be the same to improve the robustness, and different signal parameters (e.g., MCSs, RU allocations, the number of spatial streams) can improve the link adaptation process.

In a possible implementation of the first aspect, PSDUs in the multiple constituent PSDUs are different PSDUs for a same set of users and coded with different signal parameters.

In addition to testing different signal parameters (e.g., MCSs, RU allocations, the number of spatial streams), throughput can be increased with different PSDUs.

In a possible implementation of the first aspect, PSDUs in the multiple constituent PSDUs are different PSDUs for different users respectively and coded with same or different signal parameters.

The PSDUs in the aggregation of PSDUs can be destined for different users to improve the spectral efficiency in the same burst.

In a possible implementation of the first aspect, PSDUs in the multiple constituent PSDUs are of different types.

In a possible implementation of the first aspect, PSDUs in the multiple constituent PSDUs are of a same type.

In a possible implementation of the first aspect, a type of each constituent PSDU is indicated in the PHY header or the control portion of the corresponding constituent PSDU.

In a possible implementation of the first aspect, the wireless packet is transmitted over sub-7 GHz bands.

In a second aspect, an embodiment of the present disclosure provides a wireless communication method, comprising:
receiving a wireless packet, wherein the wireless packet comprises a PHY (physical layer) header and a payload portion, wherein the payload portion comprises multiple constituent physical service data units (PSDU), and each of the multiple constituent PSDUs comprises a PSDU and a control portion for the PSDU used for reception and decoding of the PSDU.

The received wireless packet can be with a frame format including multiple constituent PSDUs, and each constituent PSDU has its control portion and PSDU, with this frame format, the transmission efficiency can be improved and the transmission design can be flexible.

In a possible implementation of the second aspect, the PHY header indicates that the payload portion comprises the multiple constituent PSDUs.

The PHY header may have a function of indicating aggregation of multiple PPDUs (A-PPDU), the processing for A-PPDU may be different from that for a regular PPDU, e.g., the overhead for processing the A-PPDU may be higher than that of the regular PPDU, hence, in this way, resources can be reasonably scheduled and utilized.

In a possible implementation of the second aspect, the PHY header comprises a U-SIG field indicating that the payload portion comprises the multiple constituent PSDUs.

In a possible implementation of the second aspect, a control portion in a leading constituent PSDU of the multiple constituent PSDUs indicates that the payload portion comprises the multiple constituent PSDUs.

The indication of aggregation of multiple PPDUs (A-PPDU) can also be implemented through the control portion in the leading constituent PSDU, which provides flexibility for applications. Besides, it is also possible to implement the indication of aggregation of multiple PPDUs by using the PHY header and the control portion in the leading constituent PSDU at the same time, i.e., more than one way to indicate the A-PPDU, on one hand, the reliability of this indication can be ensured, on the other hand, there may be alternatives in case of one way is blocked.

In a possible implementation of the second aspect, the control portion in each of the multiple constituent PSDUs comprises a signal (SIG) field indicating whether the constituent PSDU is a last constituent PSDU of the payload portion.

In a possible implementation of the second aspect, for each of the multiple constituent PSDUs, the control portion in the constituent PSDU comprises receiver information indicating a destination of the PSDU in the constituent PSDU and decoding information for decoding the PSDU in the constituent PSDU.

Each constituent PSDU has its receiver information and decoding information, that is, the multiple constituent PSDUs can be independent, and in the case that a specific PSDU is missed or unable to decode, transmission of other PSDUs would not be affected.

In a possible implementation of the second aspect, for each of the multiple constituent PSDUs, the decoding information comprises a frame check sequence (FCS) for verifying decoding of the corresponding PSDU.

In the case that FCS indicates that decoding of a specific PSDU fails, this PSDU rather than all PSDUs may be requested to be retransmitted, so as to ensure all PSDUs are successfully transmitted with lower overhead.

In a possible implementation of the second aspect, for a leading constituent PSDU of the multiple constituent PSDUs, decoding information of the control portion in the leading constituent PSDU comprises:
auto gain control (AGC) information for a PSDU in the leading constituent PSDU;
channel estimation information used for decoding the PSDU in the leading constituent PSDU;
at least one signal parameter for decoding the PSDU in the leading constituent PSDU.

The above decoding information would be carried in the control portion of the leading constituent PSDU to ensure reliable data transmission.

In a possible implementation of the second aspect, the control portion in the leading constituent PSDU comprises a short training field (STF) indicating the AGC information for the PSDU in the leading constituent PSDU.

In a possible implementation of the second aspect, the control portion in the leading constituent PSDU comprises a long training field (LTF) indicating the channel estimation information for the PSDU in the leading constituent PSDU.

In a possible implementation of the second aspect, the control portion in the leading constituent PSDU comprises a signal (SIG) field indicating the at least one signal parameter for decoding the PSDU in the leading constituent PSDU.

In a possible implementation of the second aspect, the at least one signal parameter for decoding the PSDU in the leading constituent PSDU comprises at least one of following items:
a resource unit (RU) allocation of the PSDU in the leading constituent PSDU;
a modulation and coding scheme (MCS) of the PSDU in the leading constituent PSDU;
a number of spatial streams for the PSDU in the leading constituent PSDU.

In a possible implementation of the second aspect, for each of at least one constituent PSDU among the multiple constituent PSDUs other than the leading constituent PSDU, decoding information of the control portion in the constituent PSDU comprises at least one of following information:
AGC information for a PSDU in the constituent PSDU;
channel estimation information used for decoding the PSDU in the constituent PSDU;
at least one signal parameter for decoding the PSDU in the constituent PSDU.

For the constituent PSDU other than the leading constituent PSDU in the A-PPDU, it may be unnecessary to carry all the above decoding information in the control portion of the constituent PSDU, thus the overhead may be reduced in case that some information are omitted.

In a possible implementation of the second aspect, the control portion in the constituent PSDU comprises an STF indicating the AGC information for the PSDU in the constituent PSDU.

In a possible implementation of the second aspect, the control portion in the constituent PSDU comprises a LTF indicating the channel estimation information for the PSDU in the constituent PSDU.

In a possible implementation of the second aspect, the control portion in the constituent PSDU comprises a SIG indicating the at least one signal parameter for decoding the PSDU in the constituent PSDU.

In a possible implementation of the second aspect, the at least one signal parameter for decoding the PSDU in the constituent PSDU and comprises at least one of following items:
an RU allocation for the PSDU in the constituent PSDU;
an MCS for the PSDU in the constituent PSDU;
a number of spatial streams for the PSDU in the constituent PSDU.

In a possible implementation of the second aspect, the PHY header indicates at least one of following information:
a number of constituent PSDUs in the A-PPDU;
a length of each of the multiple constituent PSDUs in the A-PPDU;
a length of the control portion for each PSDU in the A-PPDU.

In a possible implementation of the second aspect, PSDUs in the multiple constituent PSDUs are same PSDUs for a same set of users and coded with different signal parameters.

The PSDUs in the aggregation of PSDUs can be the same to improve the robustness, and different signal parameters (e.g., MCSs, RU allocations, the number of spatial streams) can improve the link adaptation process.

In a possible implementation of the second aspect, PSDUs in the multiple constituent PSDUs are different PSDUs for a same set of users and coded with different signal parameters.

In addition to testing different signal parameters (e.g., MCSs, RU allocations, the number of spatial streams), throughput can be increased with different PSDUs.

In a possible implementation of the second aspect, PSDUs in the multiple constituent PSDUs are different PSDUs for different users respectively and coded with same or different signal parameters.

The PSDUs in the aggregation of PSDUs can be destined for different users to improve the spectral efficiency in the same burst.

In a possible implementation of the second aspect, PSDUs in the multiple constituent PSDUs are of different types.

In a possible implementation of the second aspect, PSDUs in the multiple constituent PSDUs are of a same type.

In a possible implementation of the second aspect, a type of each constituent PSDU is indicated in the PHY header or the control portion of the corresponding constituent PSDU.

In a possible implementation of the second aspect, the wireless packet is transmitted over sub-7 GHz bands.

In a third aspect, a wireless communication apparatus is provided by an embodiment of the present disclosure, and the apparatus comprises various modules configured to execute the wireless communication method according to the first aspect or any possible implementation of the first aspect.

In a fourth aspect, a wireless communication apparatus is provided by an embodiment of the present disclosure, and the apparatus comprises various modules configured to execute the wireless communication method according to the second aspect or any possible implementation of the second aspect.

In a fifth aspect, a wireless communication apparatus is provided by an embodiment of the present disclosure, and the apparatus comprises at least one processor, where the at least one processor is configured to execute the wireless communication method according to the first aspect or any possible implementation of the first aspect or according to the second aspect or any possible implementation of the second aspect.

In a possible implementation of the fifth aspect, the above apparatus further comprises a memory, and the memory stores instructions that cause the at least one processor to execute the wireless communication method according to the first aspect or any possible implementation of the first aspect or according to the second aspect or any possible implementation of the second aspect.

In a sixth aspect, a wireless communication apparatus is provided by an embodiment of the present disclosure, and the apparatus is configured to execute the wireless communication method according to the first aspect or any possible implementation of the first aspect or according to the second aspect or any possible implementation of the second aspect.

In a seventh aspect, a chip is provided by an embodiment of the present disclosure, and the chip comprises an input/output (I/O) interface and a processor, where the processor is configured to call and run computer execution instructions stored in a memory, to enable a device installing with the chip to execute the wireless communication method according to the first aspect or any possible implementation of the first aspect or according to the second aspect or any possible implementation of the second aspect.

In a possible implementation of the seventh aspect, the interface comprises one or more transceivers.

In an eighth aspect, a computer-readable medium is provided by an embodiment of the present disclosure, and the computer-readable medium comprises computer execution instructions which, when executed by a processor, cause the processor to execute the wireless communication method according to the first aspect or any possible implementation of the first aspect or according to the second aspect or any possible implementation of the second aspect.

In a ninth aspect, a computer program product is provided by an embodiment of the present disclosure, and the computer program product comprises computer execution instructions which, when executed by a processor, cause the processor to execute the wireless communication method according to the first aspect or any possible implementation of the first aspect or according to the second aspect or any possible implementation of the second aspect.

In a tenth aspect, a computer program is provided by an embodiment of the present disclosure, and the computer program comprises computer execution instructions which, when executed by a processor, cause the processor to execute the wireless communication method according to the first aspect or any possible implementation of the first aspect or according to the second aspect or any possible implementation of the second aspect.

A wireless communication method and related apparatus are provided by the present disclosure. The wireless packet can be transmitted with a frame format including multiple constituent PSDUs, and each constituent PSDU has its control portion and PSDU, with this frame format, the transmission efficiency can be improved and the transmission design can be flexible.

### BRIEF DESCRIPTION OF THE DRAWINGS

The accompanying drawings are used to provide a further understanding of the present disclosure, constitute a part of the specification, and are used to explain the present disclosure together with the following specific embodiments, but should not be construed as limiting the present disclosure.

FIG. 1A is a schematic illustration of a network for communicating data according to one or more embodiments of the present disclosure.

FIG. 1B is a schematic illustration of an apparatus wirelessly communicating with another apparatus within a communication system according to one or more embodiments of the present disclosure.

FIG. 2A is a schematic illustration of a frame format for a time domain aggregation of PPDU according to one or more embodiments of the present disclosure.

FIG. 2B is a schematic illustration of interaction between nodes in a communication system according to one or more embodiments of the present disclosure.

FIG. 3 is a schematic illustration of a frame format for a time domain aggregation of PPDU with the same PSDUs according to one or more embodiments of the present disclosure.

FIG. 4 is a schematic illustration of a frame format for a time domain aggregation of PPDU with different PSDUs for the same users according to one or more embodiments of the present disclosure.

FIG. 5 is a schematic illustration of a frame format for a time domain aggregation of PPDU with the UHR-LTF omitted according to one or more embodiments of the present disclosure.

FIG. 6 is a schematic illustration of a frame format for a time domain aggregation of PPDU with UHR-STF and UHR-LTFs omitted according to one or more embodiments of the present disclosure.

FIG. 7 is a schematic illustration of a frame format for a time domain aggregation of PPDU with different PSDUs and different users according to one or more embodiments of the present disclosure.

FIG. 8 is a schematic illustration of a frame format for a time domain aggregation of PPDU with different generations according to one or more embodiments of the present disclosure.

FIG. 9 is a schematic structural diagram of an apparatus according to one or more embodiments of the present disclosure.

FIG. 10 is a block diagram of an apparatus according to one or more embodiments of the present disclosure.

### DETAILED DESCRIPTION OF THE EMBODIMENTS

In the following description, reference is made to the accompanying figures, which form part of the present disclosure, and which show, by way of illustration, specific aspects of embodiments of the present disclosure or specific aspects in which embodiments of the present disclosure may be used. It is understood that embodiments of the present disclosure may be used in other aspects and include structural or logical changes not depicted in the figures. The following detailed description, therefore, is not to be taken in a limiting sense, and the scope of the present disclosure is defined by the appended claims.

The technical solutions in embodiments of the present disclosure may be applied to a wireless local area network (WLAN) system, or may be applied to a communication system of another standard, e.g., a long term evolution (LTE) system, or other future communication systems. A station (STA) and an access point (AP) are basic components of the WLAN system. The AP is an access point used by a mobile user to access a wired network, and is mainly deployed within a home, a building, and a campus, with a typical coverage radius of a few dozen meters to a few hundred meters. Certainly, the AP may also be deployed outdoors. The AP is equivalent to a bridge that connects the wired network and a wireless network. A main function of the AP is to connect wireless network clients together, and then connect the wireless network to the Ethernet. Specifically, the AP may be an apparatus with a Wi-Fi (Wireless Fidelity) chip, e.g., a terminal device or a network device with a Wi-Fi chip. In an example, the AP may be a device that supports the 802.11ax standard. In another example, the AP may be a device that supports a plurality of WLAN standards, such as 802.11ac, 802.11n, 802.11g, 802.11b, 802.11a, etc. Further, the AP may also be a device that supports 802.11be and a WLAN standard that supports other future 802.11 standards. A standard type supported by the AP is not limited in the embodiments of the present disclosure.

The STA is generally a terminal device in a WLAN system. The STA may be movable or may be fixed, and is a basic component of a wireless communication chip, a wireless sensor, or a wireless communication terminal, such as a mobile phone supporting a Wi-Fi communication function, a set-top box supporting a Wi-Fi communication function, a smart television supporting a Wi-Fi communication function, a smart wearable device supporting a Wi-Fi communication function, an in-vehicle communication device supporting a Wi-Fi communication function, or a computer supporting a Wi-Fi communication function, etc. Similarly, the STA may be a device that supports the 802.11ax standard, or the STA may be a device that supports a plurality of WLAN standards, such as 802.11ac, 802.11n, 802.11g, 802.11b, 802.11a, etc. Further, the STA may also be a device that supports 802.11be and a WLAN standard that supports other future 802.11 standards. A standard type supported by the STA is not limited in the embodiments of the present disclosure.

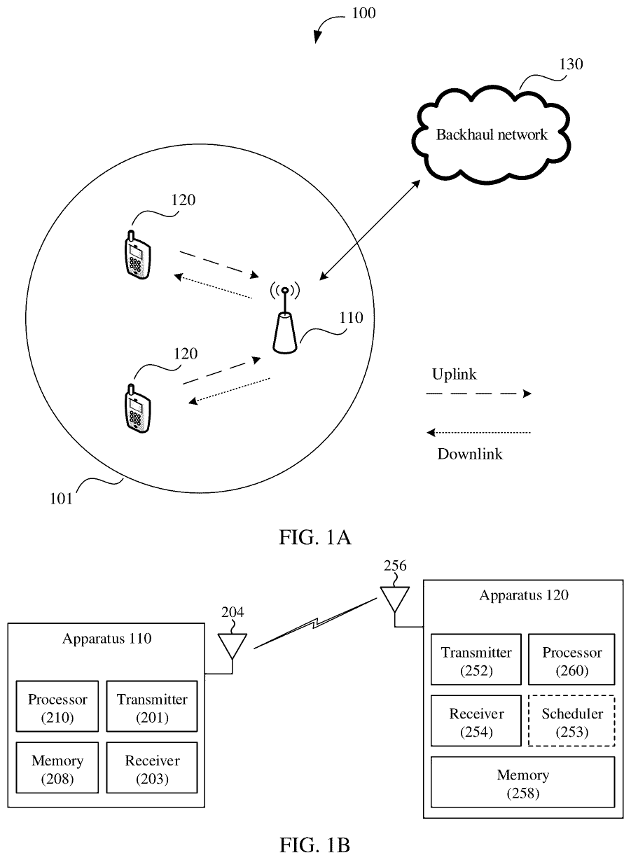

FIG. 1A is a schematic illustration of a network 100 for communicating data. The network 100 includes an access point (AP) no having a coverage area 101, a plurality of mobile devices 120, and a backhaul network 130. As shown in FIG. 1A, the AP no establishes uplink (dashed line) and/or downlink (dotted line) connections with the mobile devices 120, which serve to carry data from the mobile devices 120 to the AP no and vice-versa. Data carried over the uplink/downlink connections may include data communicated between the mobile devices 120, as well as data communicated to/from a remote-end (not shown) by way of the backhaul network 130. As used herein, the term “access point” refers to any component (or collection of components) configured to provide wireless access in a network, such as an evolved NodeB (eNB), a macro-cell, a femtocell, a Wi-Fi AP, or other wirelessly enabled devices. APs may provide wireless access in accordance with one or more wireless communication protocols, e.g., Long Term Evolution (LTE), LTE advanced (LTE-A), High Speed Packet Access (HSPA), Wi-Fi 802.11a/b/g/n/ac, etc. As used herein, the term “mobile device” refers to any component (or collection of components) capable of establishing a wireless connection with an access point, such as user equipment (UE), a mobile station (STA), and other wirelessly enabled devices. In some embodiments, the network 100 may include various other wireless devices, such as relays, low power nodes, etc.

FIG. 1B is a schematic illustration showing an apparatus 110 wirelessly communicating with another apparatus 120 within a communication system (e.g., the WLAN system) according to an implementation of the present disclosure. The apparatus 110 may be a transmitting end (e.g., STA), or the apparatus 120 may be a receiving end (e.g., AP). Although only one apparatus 110, and one apparatus 120 are shown in the figure, the number of apparatus 110 and/or number of apparatus 120 can vary, potentially including one or more of each.

The apparatus 110 may include one or more processors 210. For clarity and to avoid overcrowding the illustration, only a single processor 210 is illustrated. The apparatus 110 may further include a transmitter 201 and a receiver 203 coupled to one or more antennas 204. For clarity, only a single antenna 204 is illustrated. One, some, or all of the antennas 204 may alternatively be panels. In some implementations, the transmitter 201 and the receiver 203 are separate from each other. In other implementations, the transmitter 201 and the receiver 203 may be integrated into a single unit, for example, as a transceiver. The transceiver is configured to modulate data or other content for transmission by the one or more antennas 204 or a network interface controller (NIC). The transceiver may also be configured to demodulate data or other content received by the one or more antennas 204. A transceiver may include any suitable structure for generating signals for wireless or wired transmission and/or for processing signals received through wireless or wired communication. Each antenna 204 includes any suitable structure for transmitting and/or receiving wireless or wired signals. The apparatus 110 may include a memory 208. In some implementations, the apparatus 110 may include multiple memories 208. Only a single transmitter 201, receiver 203, processor 210, memory 208, and antenna 204 is illustrated for simplicity, but the apparatus 110 may include one or more other components. In some implementations of the present disclosure, the transceiver (or transmitter 201 and/or receiver 203) may be viewed as an interface circuit.

The memory 208 is configured to store instructions used to perform operations described herein. The memory 208 may also be configured to store data that is used, generated, or collected by the apparatus 110. For example, the memory 208 can store software instructions or modules configured to implement some or all of the functionalities and/or operations described herein and that which are executed by the one or more processors 210.

The apparatus 110 may further include one or more input/output devices (not shown) or interfaces. The input/output devices or interfaces facilitate interaction with a user or other devices in the network. Each input/output device or interface includes suitable components for facilitating transmission of information to a user and reception of information from a user, and for various network interface communications. Such components may include, but are not limited to, a speaker, microphone, keypad, keyboard, display, touch screen, and the like.

The processor 210 may be configured to perform (or control the apparatus 110 to perform) operations (or methods) described herein as being performed by the apparatus 110. For example, the processor 210 performs or controls the apparatus 110 to perform the operations of: a) receiving one or more transport blocks (TBs), b) using a resource for decoding at least one of the received TBs, c) releasing the resource for decoding another of the received TBs, and/or d) receiving configuration information configuring a resource. Specifically, the operations may include tasks related to: preparing a transmission for UL transmission to the apparatus 120, processing DL transmissions received from the apparatus 120, and handling SL transmission to and from another apparatus 110. Processing operations related to preparing a transmission for UL transmission may include operations such as, but not limited to, encoding, modulating, transmit beamforming, and generating symbols for transmission. Processing operations related to processing DL transmissions may include operations such as, but not limited to, receive beamforming, demodulating and decoding received symbols. Processing operations related to processing SL transmissions may include operations such as, but not limited to, transmit/receive beamforming, modulating/demodulating and encoding/decoding symbols. Depending upon the implementation, a DL transmission may be received by the receiver 203, possibly using receive beamforming, and the processor 210 may extract signaling from the DL transmission (such as by detecting and/or decoding the signaling). An example of signaling may be a reference signal transmitted by the apparatus 120. In some implementations, the processor 210 implements the transmit beamforming and/or the receive beamforming based on the indication of beam direction, such as beam angle information (BAI), received from the apparatus 120. In some implementations, the processor 210 may be configured to perform operations relating to network access (such as initial access) and/or downlink synchronization, which includes operations for detecting a synchronization sequence, decoding and obtaining the system information, and the like. In some implementations, the processor 210 may perform channel estimation, such as using a reference signal received from the apparatus 120.

Although not illustrated, in some implementations, the processor 210 may either be a part of the transmitter 201 or a part of the receiver 203 or a part of both the transmitter 201 and the receiver 203. Although not illustrated, in some implementations, the memory 208 may be a part of the processor 210.

The processor 210, along with the processing components of the transmitter 201 and the receiver 203 may each be implemented by one or more processors that may the same or different. These processors are configured to execute instructions stored in a memory (such as in the memory 208).

The apparatus 120 includes one or more processors 260 (only one processor 260 is illustrated). The apparatus 120 may further include one or more transmitters 252 and one or more receivers 254 coupled to one or more antennas 256. Only a single antenna 256 is illustrated to avoid clutter in the illustration. One, some, or all of the antennas 256 may alternatively be panels. In some implementations, the transmitter 252 and the receiver 254 are separate from each other. In other implementations, the transmitter 252 and the receiver 254 may be integrated into a single unit such as, for example, as a transceiver. The apparatus 120 may further include a memory 258. In some implementations, the apparatus 120 may include multiple memories 258. The apparatus 120 may further include a scheduler 253. Only a single transmitter 252, receiver 254, processor 260, memory 258, antenna 256 and scheduler 253 are illustrated for simplicity, however the apparatus 120 may include one or more other components. In the present disclosure, in some implementations, the transceiver (or transmitter 252 and/or receiver 254) may be viewed as an interface circuit.

In some implementations, various components of the apparatus 120 may be distributed. For example, some of the modules of the apparatus 120 may be located remotely from the equipment housing the antennas 256 for the apparatus 120 (and therefore also can be viewed as one or more nodes). These modules, which can be considered as one or more nodes, may be coupled to the equipment that houses the antennas 256 over a communication link (not shown), sometimes referred to as front haul, such as the Common Public Radio Interface (CPRI). Therefore, in some implementations, the term apparatus 120 may also refer to network-side nodes that perform processing operations such as, but not limited to, determining the location of the apparatus 110, resource allocation (scheduling), message generation, and encoding/decoding, and that which are not necessarily part of the equipment that houses the antennas 256 of the apparatus 120. The nodes may also be coupled to other apparatuses 120. In some implementations, the apparatus 120 may actually be a plurality of nodes that are operating together to serve the apparatus 110, such as through the use of coordinated multipoint transmissions, or through the use of ORAN system.

The processor 260 is configured to perform operations including those related to: preparing a transmission for DL transmission to the apparatus 110, processing a UL transmission received from the apparatus 110, preparing a transmission for backhaul transmission to another apparatus 120, and processing a transmission received over backhaul from another apparatus 120. Processing operations related to preparing a transmission for DL or backhaul transmission may include operations such as, but not limited to, encoding, modulating, precoding (such as MIMO precoding), transmit beamforming, and generating symbols for transmission. Processing operations related to processing received transmissions in the UL or over backhaul may include operations such as, but not limited to, receive beamforming, demodulating received symbols, and decoding received symbols. The processor 260 may also be configured to perform operations relating to network access (such as initial access) and/or DL synchronization, such as generating the content of synchronization signal blocks (SSBs), generating the system information, and the like. In some implementations, the processor 260 is further configured to generate an indication of beam direction, such as BAI, which may be scheduled for transmission by the scheduler 253 which will be described below. In some implementations, the processor 260 implements the transmit beamforming and/or receive beamforming based on beam direction information (such as BAI) received from another apparatus 120. The processor 260 is configured to perform other network side processing operations described herein, such as, but not limited to, determining the location of the apparatus 110, determining where to deploy another apparatus 120, and the like. In some implementations, the processor 260 may generate signaling data, to configure one or more parameters of the apparatus 110 and/or one or more parameters of another apparatus 120. Any signaling data generated by the processor 260 is sent by the transmitter 252. In some implementations, the apparatus 120 implements physical layer processing. In some implementations, the apparatus 120 may perform higher layer functions such as those at the Medium Access Control (MAC) or Radio Link Control (RLC) layers in addition to physical layer processing. In the apparatus 120, the scheduler 253 may be coupled to the processor 260 or integrated within the processor 260. In some implementations, the scheduler 253 may be integrated within the apparatus 120 or may be operated separately from the apparatus 120. The scheduler 253 may schedule UL, DL, SL, and/or backhaul transmissions, including issuing scheduling grants and/or configuring scheduling-free (such as “configured grant”) resources.

The apparatus 120 may further include a memory 258 that is configured to store instructions for performing the operations described herein. The memory 258 may also store data that is used, generated, or collected by the apparatus 120. For example, the memory 258 can store software instructions or modules configured to implement some or all of the functionalities and/or implementations described herein and that which are executed by the processor 260.

Although not illustrated, the processor 260 may be implemented as part of the transmitter 252 and/or a part of the receiver 254. Although not illustrated, in some implementations, the processor 260 may implement the scheduler 253 and the memory 258 may be implemented as part of the processor 260.

The processor 260, the scheduler 253, the processing components of the transmitter 252, and the processing components of the receiver 254 may each be implemented by the same or different processors that are configured to execute instructions stored in a memory, such as in the memory 258.

The apparatus 120 and/or the apparatus 110 may include other components, not shown or described herein for the sake of clarity.

Note that the term “signaling”, as used herein, may alternatively be referred to as control signaling, control message, control information, or message for simplicity. Signaling between a base station and a UE or sensing device, or signaling between a different UE or sensing device may be carried in physical layer signaling (also called as dynamic signaling), which is transmitted in a physical layer control channel. For DL, the physical layer signaling may be known as downlink control information (DCI) which is transmitted in a physical downlink control channel (PDCCH). For UL, the physical layer signaling may be known as uplink control information (UCI) which is transmitted in a physical uplink control channel (PUCCH). For SL, signaling between different UEs or sensing devices may be known as SL control information (SCI) which is transmitted in a physical sidelink control channel (PSCCH). Signaling may be carried in a higher layer (such as higher than physical layer) signaling, which is transmitted in a physical layer data channel, such as in a physical downlink shared channel (PDSCH) for downlink signaling, in a physical uplink shared channel (PUSCH) for uplink signaling, and in a physical sidelink shared channel (PSSCH) for SL signaling. Higher layer signaling may also be called static signaling, or semi-static signaling. The higher layer signaling may include radio resource control (RRC) protocol signaling or media access control-control element (MAC-CE) signaling. Signaling may be included in a combination of physical layer signaling and higher layer signaling.

It should be noted that in the present disclosure, “information”, when different from “message”, may be carried within a single message, or may be carried in multiple separate messages.

A WLAN system may be taken as an example to illustrate the technical solutions in the embodiments of the present disclosure. In the WLAN system, various frame formats such as a PPDU (physical layer protocol data unit), or aggregation of PPDUs may be transmitted between the AP and the STA.

Aggregation is a technology to improve throughput and efficiency, e.g., in high-speed wireless networks. In effect, multiple frames are combined into a single transmission to reduce overhead and increase efficiency of the available bandwidth (BW). Currently, two aggregation techniques, that is, A-MSDU and A-MPDU techniques, are adopted in the standard which logically reside at the top and the bottom of the medium access control (MAC) layer. In aggregated MAC service data unit (A-MSDU), multiple MSDUs destined for the same receiver and of the same service category are packed into a single MPDU (MAC protocol data unit), with a common MAC header and FCS (frame check sum). The aggregation of MAC protocol data unit (A-MPDU) is logically performed at the bottom of MAC layer where fully formed MAC PDUs are combined into a single transmission burst. The aggregated frame includes a single physical (PHY) header followed by a series of MPDUs, where each MPDU has its MAC header and frame check sum (FCS). Modern Wi-Fi standards (802.11ac and 802.11ax) allow combining both A-MSDU and A-MPDU techniques such that multiple A-MSDUs can be packed into a single A-MPDU.

The above describes aggregation in MAC layer, while aggregation in physical layer, e.g., aggregation of physical protocol data units (PPDUs) can be beneficial for large BW to schedule STAs (probably from mixed generations) in one transmission burst, which can improve reliability and/or efficiency.

In related art, some solutions of aggregation in the physical layer are provided. In an example, there is provided EDMG (enhanced directional multi-gigabit) A-PPDU frame format for wireless networks of 60 GHz frequency band, where each PPDU in A-PPDU shares the EDMG-CEF field, which may cause low accuracy in channel estimation. In another example, there is provided A-PSDU (aggregation of physical layer service data units) frame format, where SIG fields of the A-PSDU frame format are used for delimiting one or more PSDUs and carrying information about the following PSDU such as its length and rate. The disadvantage lies in high overhead compared to A-MPDU when data is aggregated to a single station, Moreover, any error in the SIG fields would prevent demodulation of the rest of the aggregate. Hence, the A-PSDU scheme lacks robustness. Aggregation of PPDUs in both time and frequency domains would also be possible, but there would still be inaccuracy problems.

IEEE 802.11bn Ultra-high reliability (UHR) or Wi-Fi 8 standardization is currently under development for a future generation of WLANs, following Wi-Fi 7 (IEEE 802.11be). The main goals of Wi-Fi 8 center around improving throughput, enhancing reliability, reducing latency and power consumption for APs, e.g., in challenging environments like dense urban areas. Enhancements at the MAC and PHY layers will help manage low-latency traffic more effectively. Multi-AP coordination, preemption, non-primary channel access, UEQM (unequal modulation), distributed resource units (DRU) are some of the features being studied for UHR.

In view of the above, embodiments of the present disclosure provide details on how to design a time domain aggregation of PPDUs (A-PPDU) in physical layer for UHR, which may also be referred to as UHR PPDU in some examples of the present disclosure when some or all the PSDUs forming the A-PPDU are for UHR. The proposed time domain A-PPDU (time domain aggregation of PPDU) scheme can improve reliability and/or efficiency in the same burst, and can provide time domain multiple access in addition to one of RUs (resource units) in frequency domain.

Generally, in the embodiments of the present disclosure, it is proposed to aggregate multiple PPDUs in the time domain, and each of the multiple PPDUs may share the same control information or they may have their respective control information. The control information may include, e.g., MCS (modulation and coding scheme). Certain fields in the time domain A-PPDU may also be designed to support different structures of the time domain A-PPDU.

In the following, first describe technical concepts of the proposed solution about time domain A-PPDU for UHR, then possible structures of the time domain A-PPDU would be elaborated. It should be noted that, in addition to UHR with operating capability in both sub-7 GHz and millimeter bands, the proposed time domain A-PPDU scheme may also be used for the future generation of Wi-Fi, which is not limited in the embodiments of the present disclosure.

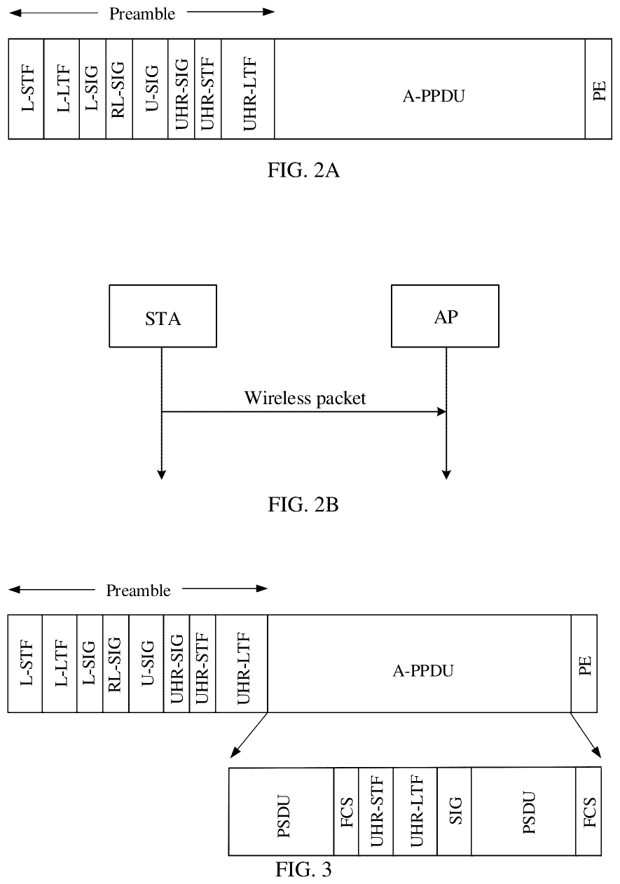

FIG. 2A is a schematic illustration of a frame format for a time domain aggregation of PPDU according to one or more embodiments of the present disclosure. In the present disclosure, as shown in FIG. 2A, a typical time domain aggregation of PPDU may include a preamble, A-PPDU, and a packet extension (PE). The preamble in the UHR PPDU may include the following fields, each of which relates to a function in the physical layer, some portion of the preamble may be used for backward compatibility, and some portion may be designed to support the time domain A-PPDU structure. It should be noted that the preamble here is just illustrative rather than restrictive, it is also possible to take L-STF, L-LTF, L-SIG, RL-SIG and U-SIG as the preamble/PHY header of the frame.

The fields of the preamble in the time domain A-PPDU are described as follows.

Legacy short training field (L-STF) may be used for the indication of the start of the packet, synchronization, frequency offset estimation, auto gain control (AGC).

Legacy long training field (L-LTF) may be used for better frequency offset estimation, synchronization, and channel estimation.

Legacy signal (L-SIG) field may include the length and rate information.

Repeated L-SIG (RL-SIG) field may repeat L-SIG field for auto-detection.

Universal SIG (U-SIG) field may be used for forward compatibility and auto-detection. This field may also include version dependent and independent information.

UHR-SIG field may include per user signal parameters and simply exist in MU (multi-user) PPDUs (not TB (Trigger-based) PPDUs). The UHR-SIG field can be used to determine the MCS, the RU allocation, etc., for the PSDU(s) following the first PSDU in the A-PPDU, and SIG field(s) may include one or more of the following fields: PHY Version Identifier; LDPC (Low Density Parity Check) Extra Symbol Segment, Pre-FEC Padding Factor, PE disambiguity, RU Allocation Subfield, User Fields, CRC field, Tail field, etc. Besides, in a possible implementation, a bit in the UHR-SIG field can indicate whether the following PSDU is the last PSDU of the aggregation.

UHR-STF may be used for improving AGC, and may also be used for confirming the existence of a new PSDU.

UHR-LTF may be used for improving the channel estimation such as in long range, as well as carrier frequency offset (CFO) correction. When the L-LTF is used for channel estimation, the result of this channel estimation is used for decoding the subsequent L-SIG field, RL-SIG field and U-SIG field. When the UHR-LTF is used for channel estimation, the result of this channel estimation is used for decoding the subsequent PSDU(s).

With respect to the A-PPDU following the preamble at the front of the time domain aggregation of PPDU, a control portion may be added before each PSDU (except the first PSDU) in the A-PPDU, which delimits one or more PSDUs in the A-PPDU and is used for decoding the corresponding PSDU in the A-PPDU. The PSDU and its corresponding control portion in together may be referred to as a constituent PSDU. In the example shown in FIG. 2A, the control portion for the first PSDU would be the shown combination of the UHR-SIG field, UHR-STF and UHR-LTF, and this combination may be used for decoding the first PSDU in the A-PPDU following the UHR-LTF. The control portion may include one or more of UHR-STF, UHR-LTF, and SIG fields, and the control portion before each PSDU is not necessary to have the same structure, various implementations would be possible.

In a possible implementation, the L-STF, L-LTF, L-SIG field, RL-SIG field may be legacy fields with backward compatibility. In another possible implementation, these fields may also be designed to support functions related with the transmission of the A-PPDU.

Since multiple PSDUs will be possibly aggregated in the exemplary format shown in FIG. 2A, some functions would be supported to indicate one or more of:
1) whether the payload portion is an aggregation of multiple PSDUs (whether the payload portion is an A-PPDU or a regular/legacy PPDU);
2) the number of PSDUs in the A-PPDU;
3) a length/length information of each PSDU in the A-PPDU;
4) a length/length information of UHR-SIG field for each PSDU in the A-PPDU in the case of the payload portion includes multiple PSDUs;
5) receiver information;
6) a length of UHR-LTF for each PSDU in the A-PPDU;
7) a type of each constituent PSDU.

It is not necessary to indicate all of the above information, some of them may be set as default values. For example, the number of PSDUs in a frame may be predefined, the length of each PSDU may also be predefined as a default value, or the length of UHR-LTF for each PSDU may also be predefined.

There is no limitation on which fields in the frame could indicate the above information.

For example, with respect to whether the payload portion is an aggregation of multiple PSDUs, one possible way is to carry such indication in the U-SIG field, another possible way is to make the UHR-SIG field for the first PSDU in the A-PPDU indicate whether the payload portion is an aggregation of multiple PSDUs, another possible way is to make the UHR-SIG field for the first PSDU in the A-PPDU and SIG field for each of PSDU(s) other than the first PSDU indicating whether the corresponding PSDU is the last PSDU.

For example, with respect to the number of PSDUs in the A-PPDU, this could be carried in the U-SIG field. In a possible implementation, the U-SIG field may have a common field, and the indication of the number of PSDUs in the A-PPDU would be carried in that field.

For example, since the length indicated in the L-SIG field is the total length of the whole frame, so in a possible implementation, in the case where PSDUs may be of different lengths, their lengths could be indicated. In a possible implementation, the indication of the length of each PSDU may be carried in the U-SIG field. In another possible implementation, the indication of the length of each PSDU may be carried in the UHR-SIG field before each PSDU.

For example, with respect to the length of UHR-SIG field for each PSDU, it could be indicated in the U-SIG field.

For example, with respect to the receiver information for each PSDU, the PSDUs in the A-PPDU may target the same or different PSDUs, such receiver information may be indicated, e.g., in the UHR-SIG field for the first PSDU in the A-PPDU.

For example, sometimes the UHR-LTF for each PSDU may have different lengths, so in that case, the length of UHR-LTF for each PSDU may also be indicated. In a possible implementation, this length could be indicated in the U-SIG field. It is also possible that each PSDU shares the same length of UHR-LTF, so in that case, the length of UHR-LTF may be indicated in the UHR-SIG field for the first PSDU (the UHR-SIG field shown in the preamble in FIG. 2A).

For example, with reference to the type of each constituent PSDU, one possible way is to indicate such type in the control portion of each constituent PSDU, e.g., each UHR-SIG field; another possible way is to indicate such type in the preamble, e.g., U-SIG field.

Further, in order to decode each PSDU in the A-PPDU, some decoding information may be needed, the decoding information may include, for example, MCS of each PSDU and/or RU allocation of each PSDU, etc.

As mentioned above, each PSDU has its corresponding control portion.

In a possible implementation, the UHR-SIG field for a corresponding PSDU may carry decoding information of the corresponding PSDU.

In another implementation, the UHR-SIG field for the first PSDU (the UHR-SIG field shown in the preamble in FIG. 2A) may carry common decoding information of the PSDUs in the A-PPDU, as well as decoding information specific to the first PSDU, then in the UHR-SIG field for each of subsequent PSDU(s) (other than the first PSDU) in the A-PPDU, the UHR-SIG field corresponding to the PSDU may include decoding information specific to this PSDU. In this case, the UHR-SIG field for the first PSDU may include two fields, common field and user specific field, and the common decoding information may be carried in the common field of the UHR-SIG field for the first PSDU. The common decoding information may include, e.g., tone plan.

In a possible implementation, the receiver would be able to decode a PSDU in the A-PPDU simply based on the decoding information indicated in the UHR-SIG field for this PSDU, without referring to UHR-SIG field for other PSDU.

In a possible implementation, the receiver would decode the first PSDU based on the UHR-SIG field for the first PSDU, and then decode subsequent PSDU(s) based on the UHR-SIG field for the first PSDU and the UHR-SIG field for the subsequent PSDU(s). For example, the UHR-SIG field for the subsequent PSDU(s) simply indicates the change of MCS/RU allocation of the subsequent PSDU(s) with respect to the MCS/RU allocation of the first PSDU. This would be possible either for the case where the UHR-SIG field for each PSDU indicates decoding information of the corresponding PSDU or the case where the UHR-SIG field for the first PSDU carrying common decoding information and the UHR-SIG field for subsequent PSDU(s) carrying decoding information specific to this PSDU.

In some cases, different PSDUs in the A-PPDU may share the same MCS, then this MCS may be indicated once for these PSDUs. It is not necessary for all the PSDUs in the A-PPDU to have the same MCS, some or all of them may share the same MCS, which is not limited in the embodiments of the present disclosure.

Besides, the PSDUs in the A-PPDU may be same PSDUs for the same set of users, or the PSDUs may be different PSDUs for the same set of users or different users, which is not limited in the embodiments of the present disclosure. Here, the same set of users may refer to a set of users with the same properties but with different RU (resource unit) allocations or different MCSs (modulation and coding scheme) or different numbers of spatial streams, while different users may refer to users with different properties.

The above describes technical concepts of the present disclosure, and then specific embodiments of the present disclosure will be elaborated in the following description.

FIG. 2B is a schematic illustration of interaction between nodes in a communication system according to one or more embodiments of the present disclosure. In an example, data transmission may be performed between the AP and the STA as mentioned before in the WLAN system.

As shown in FIG. 2B, the STA may transmit a wireless packet to the AP for data transmission. The wireless packet may be in a frame format based on the time domain aggregation of PPDU proposed by embodiments of the present disclosure, which will be described later. Regarding the transmission resource for this packet, in a possible implementation, the wireless packet with the proposed frame format may be transmitted over sub-7 GHz bands.

The wireless packet may include a PHY (physical layer) header and a payload portion, where the payload portion includes multiple constituent physical service data units (PSDU), and each of the multiple constituent PSDUs includes a PSDU and a control portion for the PSDU used for reception and decoding of the PSDU.

The wireless packet can be transmitted with a frame format including multiple constituent PSDUs, and each constituent PSDU has its control portion and PSDU, with this frame format, the transmission efficiency can be improved and the transmission design can be flexible.

As mentioned before, the frame format for the wireless packet may include the PHY header, which may be a part of a preamble of the wireless packet. The functions of the PHY header and the fields included in the PHY header will be introduced. In a possible implementation, the preamble may include the PHY header and the control portion in the first constituent PSDU among the multiple constituent PSDUs.

In a possible implementation, the PHY header indicates that the payload portion includes the multiple constituent PSDUs. The PHY header may have a function of indicating aggregation of multiple PPDUs (A-PPDU), the processing for A-PPDU may be different from that for a regular PPDU, e.g., the overhead for processing the A-PPDU may be higher than that of the regular PPDU, hence, in this way, resources can be reasonably scheduled and utilized.

In a possible implementation, the PHY header includes a U-SIG field indicating that the payload portion includes the multiple constituent PSDUs.

In a possible implementation, the PHY header indicates at least one of following information:
a number of constituent PSDUs in the A-PPDU;
a length of each of the multiple constituent PSDUs in the A-PPDU;
a length of the control portion for each PSDU in the A-PPDU.

Next, the payload portion included in the frame format will be introduced.

In a possible implementation, a control portion in a leading constituent PSDU of the multiple constituent PSDUs indicates that the payload portion includes the multiple constituent PSDUs. The indication of aggregation of multiple PPDUs (A-PPDU) can also be implemented through the control portion in the leading constituent PSDU, which provides flexibility for applications. Besides, it is also possible to implement the indication of aggregation of multiple PPDUs by using the PHY header and the control portion in the leading constituent PSDU at the same time, i.e., more than one way to indicate the A-PPDU, on one hand, the reliability of this indication can be ensured, on the other hand, there may be alternatives in case of one way is blocked.

In a possible implementation, the control portion in each of the multiple constituent PSDUs includes a signal (SIG) field indicating whether the constituent PSDU is a last constituent PSDU of the payload portion. For the first constituent PSDU and the following constituent PSDU(s) other than the last constituent PSDU, the SIG field may indicate that this constituent PSDU is not a last constituent PSDU of the payload portion; but for the last constituent PSDU, the SIG field may indicate that this constituent PSDU is a last constituent PSDU of the payload portion. Taking the number of the multiple constituent PSDUs being three as an example, the SIG field in the first constituent PSDU may indicate that this constituent PSDU is not a last constituent PSDU of the payload portion, the SIG field in the second constituent PSDU may indicate that this constituent PSDU is not a last constituent PSDU of the payload portion, while the SIG field in the third constituent PSDU may indicate that this constituent PSDU is a last constituent PSDU of the payload portion.

In the case that a SIG field of a specific PSDU indicates this PSDU is the last constituent PSDU, no more preparation for data transmission is indicated. In some embodiments, the SIG field of the control portion in the first constituent PSDU among the multiple constituent PSDUs may be illustrated as UHR-SIG field for UHR scenarios, and the SIG field of the control portion in each of constituent PSDU(s) other than the first constituent PSDU may be illustrated as SIG field.

In a possible implementation, for each of the multiple constituent PSDUs, the control portion in the constituent PSDU includes receiver information indicating a destination of the PSDU in the constituent PSDU and decoding information for decoding the PSDU in the constituent PSDU. Each constituent PSDU has its receiver information and decoding information, that is, the multiple constituent PSDUs can be independent, and in the case that a specific PSDU is missed or unable to decode, transmission of other PSDUs would not be affected.

In a possible implementation, for each of the multiple constituent PSDUs, the decoding information includes a frame check sequence (FCS) for verifying decoding of the corresponding PSDU. In the case that FCS indicates that decoding of a specific PSDU fails, this PSDU rather than all PSDUs may be requested to be retransmitted, so as to ensure all PSDUs are successfully transmitted with lower overhead.

In a possible implementation, for a leading constituent PSDU of the multiple constituent PSDUs, decoding information of the control portion in the leading constituent PSDU includes:
auto gain control (AGC) information for a PSDU in the leading constituent PSDU;
channel estimation information used for decoding the PSDU in the leading constituent PSDU;
at least one signal parameter for decoding the PSDU in the leading constituent PSDU.

The above decoding information would be carried in the control portion of the leading constituent PSDU to ensure reliable data transmission.

In a possible implementation, the control portion in the leading constituent PSDU includes a short training field (STF) indicating the AGC information for the PSDU in the leading constituent PSDU. In a possible implementation, the control portion in the leading constituent PSDU includes a long training field (LTF) indicating the channel estimation information for the PSDU in the leading constituent PSDU. In a possible implementation, the control portion in the leading constituent PSDU includes a signal (SIG) field indicating the at least one signal parameter for decoding the PSDU in the leading constituent PSDU. In a possible implementation, the at least one signal parameter for decoding the PSDU in the leading constituent PSDU may include at least one of the following items: a resource unit (RU) allocation of the PSDU in the leading constituent PSDU; a modulation and coding scheme (MCS) of the PSDU in the leading constituent PSDU; a number of spatial streams for the PSDU in the leading constituent PSDU.

In an example, the above mentioned STF, LTF, SIG fields for the leading constituent PSDU (the first PSDU in A-PPDU) may be UHR-LTF, UHR-LTF, UHR-SIG fields, and may be a part of the preamble of the frame, which cannot be omitted.

In a possible implementation, for each of at least one constituent PSDU among the multiple constituent PSDUs other than the leading constituent PSDU, decoding information of the control portion in the constituent PSDU includes at least one of following information:
AGC information for a PSDU in the constituent PSDU;
channel estimation information used for decoding the PSDU in the constituent PSDU;
at least one signal parameter for decoding the PSDU in the constituent PSDU.

For the constituent PSDU other than the leading constituent PSDU in the A-PPDU, it may be unnecessary to carry all the above decoding information in the control portion of the constituent PSDU, thus the overhead may be reduced in case that some information are omitted.

Similar to the leading constituent PSDU, for other PSDU(s) in the A-PPDU, in a possible implementation, the control portion in the constituent PSDU includes an STF indicating the AGC information for the PSDU in the constituent PSDU. In a possible implementation, the control portion in the constituent PSDU includes a LTF indicating the channel estimation information for the PSDU in the constituent PSDU. In a possible implementation, the control portion in the constituent PSDU includes a SIG indicating the at least one signal parameter for decoding the PSDU in the constituent PSDU. In a possible implementation, the at least one signal parameter for decoding the PSDU in the constituent PSDU may include at least one of the following items: an RU allocation for the PSDU in the constituent PSDU; an MCS for the PSDU in the constituent PSDU; a number of spatial streams for the PSDU in the constituent PSDU.

In a possible implementation, PSDUs in the multiple constituent PSDUs are same PSDUs for a same set of users and coded with different signal parameters. The signal parameters may include MCS, RU allocation, the number of spatial streams, etc. The PSDUs in the aggregation of PSDUs can be the same to improve the robustness, and different signal parameters (e.g., MCSs) can improve the link adaptation process.

In a possible implementation, PSDUs in the multiple constituent PSDUs are different PSDUs for a same set of users and coded with different signal parameters. In addition to testing different signal parameters (e.g., MCSs), throughput can be increased with different PSDUs.

In a possible implementation, PSDUs in the multiple constituent PSDUs are different PSDUs for different users respectively and coded with same or different signal parameters. The PSDUs in the aggregation of PSDUs can be destined for different users to improve the spectral efficiency in the same burst.

The type of the PSDUs in the A-PPDU may be designed according to actual requirements. In a possible implementation, PSDUs in the multiple constituent PSDUs are of different types. In a possible implementation, PSDUs in the multiple constituent PSDUs are of a same type. In a possible implementation, a type of each constituent PSDU is indicated in the PHY header or the control portion of the corresponding constituent PSDU.

Next, the following will describe the proposed solutions with possible frame formats or structures of the time domain A-PPDU. It should be noted that, the following examples are only illustrative but not restrictive.

### Example 1

FIG. 3 is a schematic illustration of a frame format for a time domain aggregation of PPDU with the same PSDUs.

This example will be described with reference to FIG. 3, the PSDUs in the aggregate (A-PPDU) can be the same to improve the robustness, e.g., in long range scenarios. Different RUs or MCSs can be used for the PSDUs in the aggregate. Different MCSs can improve the link adaptation process, specifically ARF (Auto Rate Fall-back). In the ARF, the data rate is increased if several packet transmissions were successful, otherwise the data rate is reduced in case of failure in the packet transmission. Using the time domain A-PPDU proposed in this example, more than one MCS can be tested in a single burst, and hence the link adaptation can converge faster. Different RUs (may be in different subchannels) can also increase the robustness if a subchannel is experiencing interference. In the Ack, the best MCS or RU among the tested ones for the transmission can be indicated.

As shown in FIG. 3, the time domain A-PPDU includes a preamble, A-PPDU, and a packet extension (PE), relevant description of the preamble fields may be understood with reference to the relevant description of FIG. 2A, which will not be repeated here for the sake of brevity.

The A-PPDU includes two PSDUs in FIG. 3, where the UHR-SIG field, the UHR-STF and the UHR-LTF in the preamble belong to the first PSDU in the A-PPDU, and UHR-STF, UHR-LTF and SIG fields belong to the PSDU coming after those fields. The FCS field belongs to the PSDU coming before the FCS, and is for each user's data present in corresponding PSDU in the present disclosure.

It should be noted that the number of PSDUs (i.e., two PSDUs) included in the A-PPDU in FIG. 3 is only illustrative but not restrictive, and the number of PSDUs included in the A-PPDU can be more than two, which is not limited in the present disclosure.

In a possible implementation, the UHR-STF, UHR-LTF and SIG fields for a PSDU following the first PSDU in the A-PPDU may be in the order as shown in FIG. 3, that is, the UHR-STF and UHR-LTF may be before the SIG field, so as to ensure priority for synchronization and channel estimation.

In a possible implementation, the U-SIG field in the preamble or the UHR-SIG field for the first PSDU in the A-PPDU may indicate a type of the UHR PPDU, e.g., the PPDU is aggregated PPDU or regular PPDU. In a possible implementation, the UHR-SIG field may also indicate the number of PSDUs in the A-PPDU, e.g., through a common field of the UHR-SIG field. In a possible implementation, the UHR-SIG/SIG field may also indicate length information for each PSDU in the A-PPDU. In case of the UHR PPDU being the aggregated PPDU, the UHR-SIG field may also indicate a length of UHR-SIG/SIG field for each PSDU in the A-PPDU. In a possible implementation, the UHR-SIG/SIG field may indicate length of UHR-LTF for each PSDU in the A-PPDU. In the case that all PSDUs shares the same length of UHR-LTF, the length of UHR-LTF may be only indicated in the UHR-SIG for the first PSDU to save overhead.

In a possible implementation, the UHR-SIG field or the SIG field may include receiver information and per user signal parameters. The SIG field in the aggregated portion (i.e., A-PPDU) shows the change in signal parameters, e.g., RU allocation or MCS.

In a possible implementation, functions of the UHR-SIG and SIG fields may be the same, that is, the first UHR-SIG field may indicate decoding information of the first PSDU in the A-PPDU, while the second SIG field may indicate control information of the second PSDU in the A-PPDU. The decoding information may be RU allocation, MCS, etc.

In a possible implementation, functions of the UHR-SIG and SIG fields may be different. For example, the first UHR-SIG field may indicate common information for all PSDUs in the A-PPDU, while the second SIG field (as well as SIG field for other PSDU if there's any) may indicate decoding information specific to a corresponding PSDU in the A-PPDU.

### Example 2

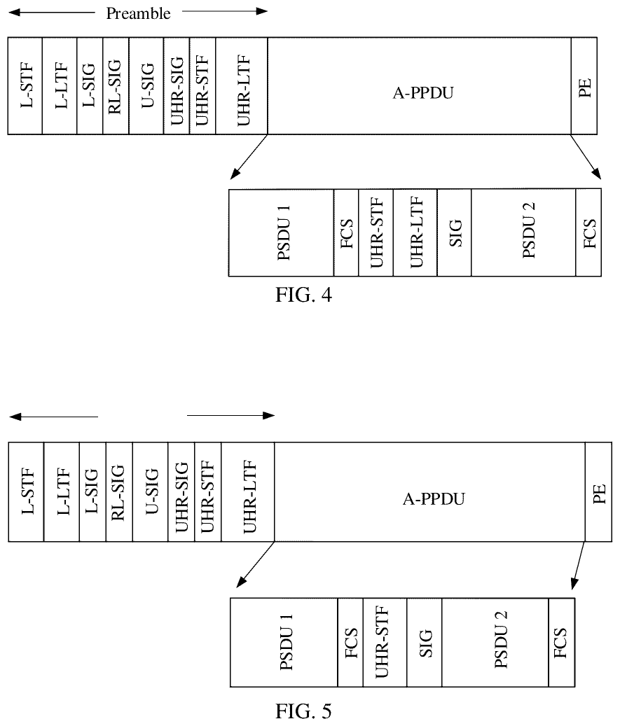

FIG. 4 is a schematic illustration of a frame format for a time domain aggregation of PPDU with different PSDUs for the same users.

This example will be described with reference to FIG. 4, different PSDUs in the aggregate (A-PPDU portion) can be destined to the same users to improve the robustness. The PSDUs are different in this example, but the target users are the same. Different RUs or MCSs can be used for the PSDUs. With this frame format, throughput can be increased in addition to testing MCSs and RUs mentioned in example 1, since different PSDUs are transmitted.

The functions of the preamble fields in the frame format of A-PPDU are the same as the previous example, relevant description of the preamble fields may be understood with reference to the relevant description of FIG. 2A, which will not be repeated here for the sake of brevity.

Regarding the A-PPDU portion, compared to example 1, the difference lies in that the PSDUs are different in this example, while the PSDUs in example 1 are the same. Therefore, some per user signal parameters (e.g., MCS, RU allocation, etc.) are changed in PSDU2 compared to PSDU1. Relevant description of similar part may be understood with reference to the relevant description of example 1, which will not be repeated here for the sake of brevity.

Similarly, the number of PSDUs (i.e., two PSDUs, PSDU1 and PSDU2) included in the A-PPDU in FIG. 4 is only illustrative but not restrictive, and the number of PSDUs included in the A-PPDU can be more than two, which is not limited in the present disclosure.

### Example 3

FIG. 5 is a schematic illustration of a frame format for a time domain aggregation of PPDU with the UHR-LTF omitted.

This example will be described with reference to FIG. 5, as shown in FIG. 5, UHR-LTF(s) for PSDU(s) other than the first PSDU is omitted. Extra UHR-LTFs can lead to improvements in the channel estimation. In order to have a fair comparison between different features of PSDUs (e.g., MCS, RU allocation, etc.), that is, all PSDUs share the same channel estimation through the UHR-LTF for the first PSDU in the preamble portion, the UHR-LTF(s) in the aggregated portion (A-PPDU portion) can be omitted.

The functions of the preamble fields in the frame format of A-PPDU are the same as the previous example, relevant description of the preamble fields may be understood with reference to the relevant description of FIG. 2A, which will not be repeated here for the sake of brevity.

Regarding the A-PPDU portion, compared to example 2, the difference lies in that the UHR-LTF(s) is omitted. Relevant description of similar part may be understood with reference to the relevant description of example 2, which will not be repeated here for the sake of brevity.

Similarly, the number of PSDUs (i.e., two PSDUs, PSDU1 and PSDU2) included in the A-PPDU in FIG. 5 is only illustrative but not restrictive, and the number of PSDUs included in the A-PPDU can be more than two, which is not limited in the present disclosure.

It should be noted that, the PSDUs in the A-PPDU may be the same or different, and in the case of different PSDUs including in the A-PPDU, the set of receivers may be the same set of users or different users.

### Example 4

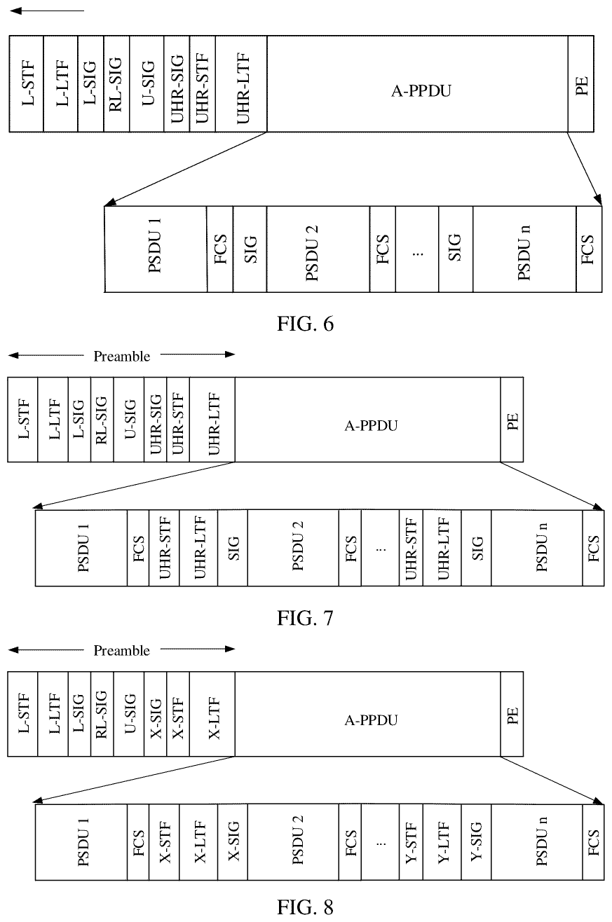

FIG. 6 is a schematic illustration of a frame format for a time domain aggregation of PPDU with UHR-STF and UHR-LTFs omitted.

This example will be described with reference to FIG. 6, as shown in FIG. 6, compared to the frame format in FIG. 5, in addition to the UHR-LTF, UHR-STF for each PSDU is also removed from the aggregated portion (A-PPDU portion) and only the SIG fields are kept to delimit the PSDUs. This scheme can reduce overhead caused by UHR-STF and UHR-LTFs in the aggregate (A-PPDU portion). In this case, the SIG field can be used to determine existence of a corresponding PSDU, e.g., CRC (cyclic redundancy check) in the SIG field can be used to determine existence of the corresponding PSDU. Although sometimes robustness may be affected since error in the SIG field would cause difficulty in the demodulation of the rest of the aggregation, but the omission may be helpful for further reducing the overhead, which is thus especially useful for the case where the overhead is restricted.

The functions of the preamble fields in the frame format of A-PPDU are the same as the previous example; relevant description of the preamble fields may be understood with reference to the relevant description of FIG. 2A, which will not be repeated here for the sake of brevity.

Regarding the A-PPDU portion, compared to example 3, the difference lies in that UHR-STFs are removed in this example. Relevant description of similar part may be understood with reference to the relevant description of the previous examples, which will not be repeated here for the sake of brevity.

It should be noted that in the case where the A-PPDU includes multiple PSDUs, then control portions for respective PSDUs may have the same structure, or may have different structures, which are not limited herein. With respect to the omission, although FIG. 6 shows the case of removing UHR-STF and UHR-LTFs for all PSDUs other than the first PSDU, it should be noted that, in some cases, it may be unnecessary for all PSDUs other than the first PSDU with both UHR-STF and UHR-LTF omitted. For example, UHR-STF is omitted for all PSDUs other than the first PSDU, but some PSDUs still hold UHR-LTF, while it is omitted for other PSDUs, considering that the length of UHR-LTF for PSDU can be indicated in the UHR-SIG/SIG field. There may be other examples, which is not limited in the embodiments of the present disclosure.

It should also be noted that, the PSDUs in the A-PPDU may be the same or different, and in the case of different PSDUs including in the A-PPDU, the set of receivers may be the same set of users or different users.

### Example 5

FIG. 7 is a schematic illustration of a frame format for a time domain aggregation of PPDU with different PSDUs and different users.

This example will be described with reference to FIG. 7, different PSDUs in the aggregate (A-PPDU portion) can be destined for different receivers to improve the spectral efficiency in the same burst. Aggregation provides time domain multiple access in addition to one of RUs in frequency domain.

The functions of the preamble fields in the frame format of A-PPDU are the same as the previous example, relevant description of the preamble fields may be understood with reference to the relevant description of FIG. 2A, which will not be repeated here for the sake of brevity.

Regarding the A-PPDU portion, compared to example 2, the difference lies in that the PSDUs are destined to different users in this example, while the PSDUs are destined to the same users in example 2. Relevant description of similar part may be understood with reference to the relevant description of examples 1 and 2, which will not be repeated here for the sake of brevity.

By using the proposed frame format, PSDUs targeting different receivers would be aggregated together, thus improving the overall throughout.

### Example 6

FIG. 8 is a schematic illustration of a frame format for a time domain aggregation of PPDU with different generations.

This example will be described with reference to FIG. 8, as shown in FIG. 8, compared to the frame format in FIG. 7, the type of PPDU in the time domain A-PPDU is not limited to UHR PPDU. It may be possible to aggregate different types of PPDUs within one time domain A-PPDU. The type of each PPDU segment can be indicated in each SIG field of the PPDU segment or can be indicated in the first SIG field. In FIG. 8, “X” and “Y” can be the futures generations of Wi-Fi and can be different for each PSDU. Here “X” and “Y” are not limited to be the same generations of Wi-Fi.

The functions of the preamble fields in the frame format of A-PPDU are the same as the previous example, relevant description of the preamble fields may be understood with reference to the relevant description of FIG. 2A, which will not be repeated here for the sake of brevity.

Regarding the A-PPDU portion, compared to example 5, the difference lies in that the type of PPDU is not limited to UHR PPDU. Relevant description of similar part may be understood with reference to the relevant description of the previous examples, which will not be repeated here for the sake of brevity.

By adding control portion for each PSDU, it becomes much easier for accommodating different generations. The transmitter would be able to aggregate different kinds of PSDUs together to better use the frequency resources.

Next, embodiments of products related to the method will be described.

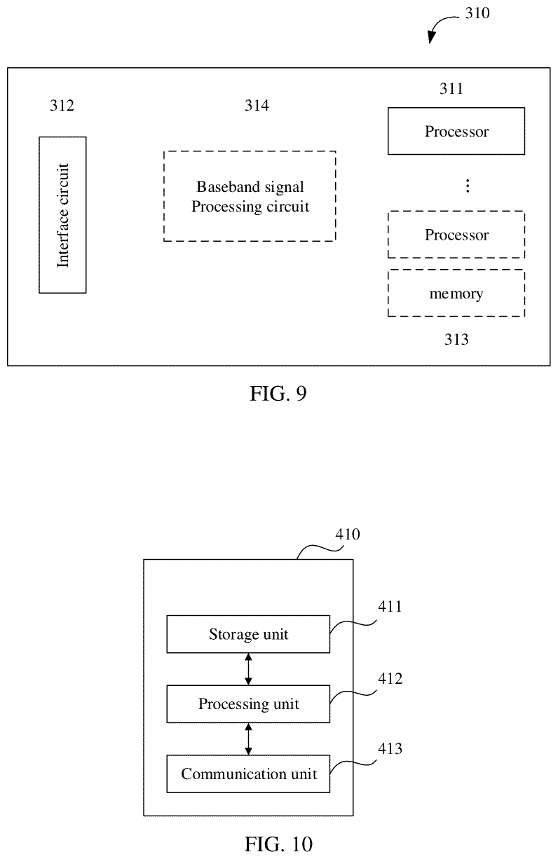

FIG. 9 illustrates an example apparatus 310 according to an implementation of the present disclosure. The apparatus 310 may be a communication device or an apparatus implemented in a communication device. For example, the apparatus 310 implemented in an STA may be an integrated circuit, which in some instances may be referred to as a chip, a modem, a modem chip, a baseband chip, or a baseband processor. In some implementations, one or more integrated circuits can be packaged into a system-on-chip, a system-in-package, or a multi-chip module. The apparatus 310 can include one or more integrated circuits and other discrete components. In some implementations, the apparatus 310 may be a module within the STA, or within the apparatus 110. In some implementations, the apparatus 310 may be a module within the AP, or the apparatus 120.

In an example, the apparatus 310 may include one or more processors 311, and an interface circuit 312. The apparatus 310 may further include a memory 313. The one or more processors 311 are configured to process signals and execute one or more communication protocols. The memory 313 is configured to store at least a part of corresponding computer program instructions and/or data. In an example, the one or more processors 311 execute the computer program instructions stored in the memory 313 to implement related operations (for example, inputting, outputting, receiving, and transmitting) in the method embodiments disclosed herein. In some implementations, the memory 313 being configured to store the corresponding computer program instructions and/or data may mean that the memory 313 is configured to store all of the corresponding computer program instructions and/or data for execution by the one or more processors 311. In some implementations, the memory 313 being configured to store the corresponding computer program instructions and/or data may mean that the memory 313 is configured to store a part of the corresponding computer program instructions and/or data. For example, the part of the corresponding computer program instructions and/or data may include computer program instructions and/or data that need to be currently executed by the one or more processors 311. Thus, the memory 313 may store different parts of computer program instructions and/or data for a plurality times for the one or more processors 311 to perform related operations in the method embodiments disclosed herein. As a communication interface, the interface circuit 312 is configured to implement communication with another component. For example, the interface circuit 312 may communicate a signal with another apparatus or system, such as a radio frequency processing apparatus or another processor. The signal may include or carry information intended as a payload, such as user data, control information, etc. The signal may also include or carry information useful to a receiver, but not necessarily as a payload, such as a pilot signal or reference signal. Communicating the signal may include transmitting the signal to another component or device. Communicating the signal may additionally or alternatively include receiving the signal from another component or device. Transmitting the signal may include outputting the signal to a component or device that is directly or indirectly coupled to the interface circuit 312. Receiving the signal may include inputting or obtaining the signal from a component or device that is directly or indirectly coupled to the interface circuit 312. Optionally, to reduce a load of the one or more processors, a baseband signal processing circuit 314 may be also disposed to implement processing of at least a part of baseband signals, including signal demodulation, modulation, encoding, decoding, or the like.

The apparatus 310 may be the processor 210 (or 260) within the apparatus 110 (or 120), in some scenarios, or may be included within the processor 210 (or 260) within the apparatus 110 (or 120) in some scenarios. The apparatus 310 may be a baseband chip or may include a baseband chip. In some implementations, the apparatus 310 may be independently packaged into a chip. In some implementations, the apparatus 110 (or 120) includes different types of chips. The apparatus 310 may be packaged into a processor chip (for example, an SoC chip or an SIP chip) with the different types of chips. In some implementations, the apparatus 310 may be packaged into a chip with some or all of circuits of a radio frequency processing system that may further be included in the apparatus 110 (or 120).

FIG. 10 illustrates an example apparatus 410 according to an implementation of the present disclosure. The apparatus 410 may include corresponding modules or units configured to implement methods and/or implementations described herein. In some implementations, the apparatus 410 includes a processing unit 412 and a communication unit 413. The processing unit 412 may be configured to prepare the wireless packet, and the communication unit 413 may be configured to transmit or receive the wireless packet. Optionally, the apparatus 410 may further include a storage unit 411 configured to store apparatus program code (or instructions) and/or data.

The apparatus 410 may be an STA side apparatus, for example, an STA or a module in an STA, or a circuit or a chip responsible for a communication function in an STA. In some implementations, the apparatus 410 may be the apparatus 110. The processing unit 412 may be the processor 210. The communication unit 413 may comprise a receiving unit and/or a transmitting unit. The receiving unit and/or the transmitting unit may be the transmitter 201 and/or the receiver 203 respectively. The storage unit 411 may be the memory 208.

The apparatus 410 may be an AP side apparatus, for example, an AP or a module in an AP, or a circuit or a chip responsible for a communication function in an AP. In some implementations, apparatus 410 may be apparatus 120. The processing unit 412 may be the processor 260 (the scheduler 253 may also be included). The communication unit 413 may comprise a receiving unit and/or a transmitting unit. The receiving unit and/or the transmitting unit may be the transmitter 252 and/or the receiver 254 respectively. The storage unit 411 may be the memory 258.

In some implementations, when the apparatus 410 is an STA or a module in an STA, a function of the apparatus 410 may be implemented by one or more processors. Specifically, the processor may include a modem chip, or a system on chip (SoC) chip or an SIP chip that includes a modem core. A function of the communication unit 413 may be implemented by a transceiver circuit.

In some implementations, when the apparatus 410 is a circuit or a chip that is responsible for a communication function in an STA, —such as a modem chip, a system on chip (SoC) chip or an SIP chip that includes a modem core—a function of the processing unit 412 may be implemented by a circuit system within the chip which includes one or more processors. A function of the communication unit 413 may be implemented by an interface circuit or a data transceiver circuit on the chip.

It may be understood that the units in the apparatus 410 may be logical or functional. Each function may correspond to one functional unit, or two or more functions may be integrated into a single functional unit. In actual implementation, all or some of the units may be integrated into a single physical entity, or may be distributed across different physical entities. In addition, the functional units may be implemented in the form of hardware, software, or a combination of hardware and software. Whether a function is implemented in the form of hardware or software depends on particular applications and design constraint conditions of the technical solutions. A person skilled in the art may use different methods to implement the described functions for specific applications, but it should not be considered that the implementation goes beyond the scope of this disclosure.

In an example, a functional unit in any one of the apparatuses may be configured as one or more integrated circuits for implementing the methods disclosed herein, for example, as one or more application-specific integrated circuits (application-specific integrated circuits, ASICs), one or more central processing units (CPUs), one or more microprocessors or microprocessor units (MPUs), one or more microcontrollers or microcontroller units (MCUs), one or more digital signal processors (DSPs), one or more field programmable gate arrays (FPGAs), or a combination of these.

In an example, the storage unit 411 may include a random access memory, a flash memory, a read-only memory, a programmable read-only memory, an electrically erasable programmable memory, and/or a register.

A processor may be referred to as a processor system, an application processor, a baseband processor, a processor circuit, or a processor core. The processor may include one or a combination of one or more central processing units (CPUs), one or more digital signal processors (DSPs), one or more microprocessors (microprocessor units, MPUs), one or more microcontrollers (microcontroller units, MCUs), one or more graphics processing units (GPUs), one or more field programmable gate arrays (FPGAs), one or more artificial intelligence processors (AI processors), or one or more neural network processing units (NPUs).

Memory or a storage unit may include one or more of the following storage media: a random access memory (RAM), a static random access memory (static RAM, SRAM), a dynamic random access memory (dynamic RAM, DRAM), a phase-change memory (PCM), a resistive random access memory (resistive RAM, ReRAM), a magnetoresistive random access memory (magnetoresistive RAM, MRAM), a ferroelectric random access memory (ferroelectric RAM, FRAM), a cache, a register, a read-only memory (ROM), a flash memory (flash memory), an erasable programmable read-only memory (erasable programmable ROM, EPROM), a hard disk, and the like. In an example, computer program instructions used to execute embodiments may be stored in a non-volatile memory, for example, at least a part of a memory or storage unit (for example, one or more of a ROM, a flash memory, an EPROM, or a hard disk). When a terminal runs, a part or all of corresponding computer program instructions may be loaded to a memory that has a higher transmission speed with the processor, for example, at least a part of a memory or a storage unit (for example, one or more of a RAM, an SRAM, a DRAM, a PCM, a RERAM, an MRAM, a FRAM, a cache, or a register), so that the processor executes the computer program instructions to perform the steps in the method embodiments disclosed herein.

The embodiments may further be described using the following clauses.

1. A wireless communication method, including:
transmitting a wireless packet, where the wireless packet includes a physical layer (PHY) header and a payload portion, where the payload portion includes multiple constituent physical service data units (PSDU), and each of the multiple constituent PSDUs includes a PSDU and a control portion for the PSDU used for reception and decoding of the PSDU.

2. The method according to clause 1, where the PHY header indicates that the payload portion includes the multiple constituent PSDUs.

3. The method according to clause 2, where the PHY header includes a U-SIG field indicating that the payload portion includes the multiple constituent PSDUs.

4. The method according to clause 1, where a control portion in a leading constituent PSDU of the multiple constituent PSDUs indicates that the payload portion includes the multiple constituent PSDUs.

5. The method according to any one of clauses 1 to 4, where a control portion in each of the multiple constituent PSDUs includes a signal (SIG) field indicating whether the constituent PSDU is a last constituent PSDU of the payload portion.

6. The method according to any one of clauses 1 to 5, where for each of the multiple constituent PSDUs, the control portion in the constituent PSDU includes receiver information indicating a destination of the PSDU in the constituent PSDU and decoding information for decoding the PSDU in the constituent PSDU.

7. The method according to clause 6, where for each of the multiple constituent PSDUs, the decoding information includes a frame check sequence (FCS) for verifying decoding of the corresponding PSDU.

8. The method according to clause 7, where for a leading constituent PSDU of the multiple constituent PSDUs, decoding information of the control portion in the leading constituent PSDU includes:
auto gain control (AGC) information for a PSDU in the leading constituent PSDU;
channel estimation information used for decoding the PSDU in the leading constituent PSDU;
at least one signal parameter for decoding the PSDU in the leading constituent PSDU.

9. The method according to clause 8, where the control portion in the leading constituent PSDU includes a short training field (STF) indicating the AGC information for the PSDU in the leading constituent PSDU.

10. The method according to clause 8 or 9, where the control portion in the leading constituent PSDU includes a long training field (LTF) indicating the channel estimation information for the PSDU in the leading constituent PSDU.

11. The method according to any one of clauses 8 to 10, where the control portion in the leading constituent PSDU includes a signal (SIG) field indicating the at least one signal parameter for decoding the PSDU in the leading constituent PSDU.

12. The method according to clause 11, where the at least one signal parameter for decoding the PSDU in the leading constituent PSDU includes at least one of following items:
a resource unit (RU) allocation of the PSDU in the leading constituent PSDU;
a modulation and coding scheme (MCS) of the PSDU in the leading constituent PSDU;
a number of spatial streams for the PSDU in the leading constituent PSDU.

13. The method according to any one of clauses 8 to 12, where for each of at least one constituent PSDU among the multiple constituent PSDUs other than the leading constituent PSDU, decoding information of the control portion in the constituent PSDU includes at least one of following information:
AGC information for a PSDU in the constituent PSDU;
channel estimation information used for decoding the PSDU in the constituent PSDU;
at least one signal parameter for decoding the PSDU in the constituent PSDU.

14. The method according to clause 13, where the control portion in the constituent PSDU includes an STF indicating the AGC information for the PSDU in the constituent PSDU.

15. The method according to clause 13 or 14, where the control portion in the constituent PSDU includes a LTF indicating the channel estimation information for the PSDU in the constituent PSDU.

16. The method according to any one of clauses 13 to 15, where the control portion in the constituent PSDU includes a SIG indicating the at least one signal parameter for decoding the PSDU in the constituent PSDU.

17. The method according to any one of clauses 13 to 16, where the at least one signal parameter for decoding the PSDU in the constituent PSDU includes at least one of following items:
an RU allocation for the PSDU in the constituent PSDU;
an MCS for the PSDU in the constituent PSDU;
a number of spatial streams for the PSDU in the constituent PSDU.

18. The method according to any one of clauses 1 to 17, where the PHY header indicates at least one of following information:
a number of constituent PSDUs in the A-PPDU;
a length of each of the multiple constituent PSDUs in the A-PPDU;
a length of the control portion for each PSDU in the A-PPDU.

19. The method according to any one of clauses 1 to 18, where PSDUs in the multiple constituent PSDUs are same PSDUs for a same set of users and coded with different signal parameters.

20. The method according to any one of clauses 1 to 18, where PSDUs in the multiple constituent PSDUs are different PSDUs for a same set of users and coded with different signal parameters.

21. The method according to any one of clauses 1 to 18, where PSDUs in the multiple constituent PSDUs are different PSDUs for different users respectively and coded with same or different signal parameters.

22. The method according to any one of clauses 1 to 21, where PSDUs in the multiple constituent PSDUs are of different types.

23. The method according to any one of clauses 1 to 21, where PSDUs in the multiple constituent PSDUs are of a same type.

24. The method according to any one of clauses 1 to 23, where a type of each constituent PSDU is indicated in the PHY header or the control portion of the corresponding constituent PSDU.

25. The method according to any one of clauses 1 to 24, where the wireless packet is transmitted over sub-7 GHz bands.

26. A wireless communication method, including:
receiving a wireless packet, where the wireless packet includes a physical layer (PHY) header and a payload portion, where the payload portion includes multiple constituent physical service data units (PSDU), and each of the multiple constituent PSDUs includes a PSDU and a control portion for the PSDU used for reception and decoding of the PSDU.

27. The method according to clause 26, where the PHY header indicates that the payload portion includes the multiple constituent PSDUs.

28. The method according to clause 27, where the PHY header includes a U-SIG field indicating that the payload portion includes the multiple constituent PSDUs.

29. The method according to clause 26, where a control portion in a leading constituent PSDU of the multiple constituent PSDUs indicates that the payload portion includes the multiple constituent PSDUs.

30. The method according to any one of clauses 26 to 29, where a control portion in each of the multiple constituent PSDUs includes a signal (SIG) field indicating whether the constituent PSDU is a last constituent PSDU of the payload portion.

31. The method according to any one of clauses 26 to 30, where for each of the multiple constituent PSDUs, the control portion in the constituent PSDU includes receiver information indicating a destination of the PSDU in the constituent PSDU and decoding information for decoding the PSDU in the constituent PSDU.

32. The method according to clause 31, where for each of the multiple constituent PSDUs, the decoding information includes a frame check sequence (FCS) for verifying decoding of the corresponding PSDU.

33. The method according to clause 32, where for a leading constituent PSDU of the multiple constituent PSDUs, decoding information of the control portion in the leading constituent PSDU includes:
auto gain control (AGC) information for a PSDU in the leading constituent PSDU;
channel estimation information used for decoding the PSDU in the leading constituent PSDU;
at least one signal parameter for decoding the PSDU in the leading constituent PSDU.

34. The method according to clause 33, where the control portion in the leading constituent PSDU includes a short training field (STF) indicating the AGC information for the PSDU in the leading constituent PSDU.

35. The method according to clause 33 or 34, where the control portion in the leading constituent PSDU includes a long training field (LTF) indicating the channel estimation information for the PSDU in the leading constituent PSDU.

36. The method according to any one of clauses 33 to 35, where the control portion in the leading constituent PSDU includes a signal (SIG) field indicating the at least one signal parameter for decoding the PSDU in the leading constituent PSDU.

37. The method according to clause 36, where the at least one signal parameter for decoding the PSDU in the leading constituent PSDU includes at least one of following items:
a resource unit (RU) allocation of the PSDU in the leading constituent PSDU;
a modulation and coding scheme (MCS) of the PSDU in the leading constituent PSDU;
a number of spatial streams for the PSDU in the leading constituent PSDU.

38. The method according to any one of clauses 33 to 37, where for each of at least one constituent PSDU among the multiple constituent PSDUs other than the leading constituent PSDU, decoding information of the control portion in the constituent PSDU includes at least one of following information:
AGC information for a PSDU in the constituent PSDU;
channel estimation information used for decoding the PSDU in the constituent PSDU;
at least one signal parameter for decoding the PSDU in the constituent PSDU.

39. The method according to clause 38, where the control portion in the constituent PSDU includes an STF indicating the AGC information for the PSDU in the constituent PSDU.

40. The method according to clause 38 or 39, where the control portion in the constituent PSDU includes a LTF indicating the channel estimation information for the PSDU in the constituent PSDU.

41. The method according to any one of clauses 38 to 40, where the control portion in the constituent PSDU includes a SIG indicating the at least one signal parameter for decoding the PSDU in the constituent PSDU.

42. The method according to any one of clauses 38 to 41, where the at least one signal parameter for decoding the PSDU in the constituent PSDU includes at least one of following items:
an RU allocation for the PSDU in the constituent PSDU;
an MCS for the PSDU in the constituent PSDU;
a number of spatial streams for the PSDU in the constituent PSDU.

43. The method according to any one of clauses 26 to 42, where the PHY header indicates at least one of following information:
a number of constituent PSDUs in the A-PPDU;
a length of each of the multiple constituent PSDUs in the A-PPDU;
a length of the control portion for each PSDU in the A-PPDU.

44. The method according to any one of clauses 26 to 43, where PSDUs in the multiple constituent PSDUs are same PSDUs for a same set of users and coded with different signal parameters.

45. The method according to any one of clauses 26 to 43, where PSDUs in the multiple constituent PSDUs are different PSDUs for a same set of users and coded with different signal parameters.

46. The method according to any one of clauses 26 to 43, where PSDUs in the multiple constituent PSDUs are different PSDUs for different users respectively and coded with same or different signal parameters.

47. The method according to any one of clauses 26 to 46, where PSDUs in the multiple constituent PSDUs are of different types.

48. The method according to any one of clauses 26 to 46, where PSDUs in the multiple constituent PSDUs are of a same type.

49. The method according to any one of clauses 26 to 48, where a type of each constituent PSDU is indicated in the PHY header or the control portion of the corresponding constituent PSDU.

50. The method according to any one of clauses 26 to 49, where the wireless packet is transmitted over sub-7 GHz bands.

51. A wireless communication apparatus, configured to perform the method according to any one of clauses 1 to 25 or 26 to 50.

52. The apparatus of clause 51, comprising: a transmitting module configured to transmit a wireless packet, where the wireless packet includes a physical layer (PHY) header and a payload portion, where the payload portion includes multiple constituent physical service data units (PSDU), and each of the multiple constituent PSDUs includes a PSDU and a control portion for the PSDU used for reception and decoding of the PSDU.

53. The apparatus of clause 51, comprising: a receiving module, configured to receive a wireless packet, where the wireless packet includes a physical layer (PHY) header and a payload portion, where the payload portion includes multiple constituent physical service data units (PSDU), and each of the multiple constituent PSDUs includes a PSDU and a control portion for the PSDU used for reception and decoding of the PSDU.

54. The apparatus of clause 51, comprising:
one or more processors configured to prepare a wireless packet, where the wireless packet includes a physical layer (PHY) header and a payload portion, where the payload portion includes multiple constituent physical service data units (PSDU), and each of the multiple constituent PSDUs includes a PSDU and a control portion for the PSDU used for reception and decoding of the PSDU; and
an interface circuit configured to transmit or receive the wireless packet.

55. The apparatus of clause 54, where the interface circuit includes one or more transceivers.

56. A wireless communication apparatus, comprising:
one or more processors; and
a memory storing instructions which, when executed by the one or more processors, cause the apparatus to perform the method according to any one of clauses 1 to 25 or 26 to 50.

57. A wireless communication system, comprising:
a first communication apparatus configured to perform the method according to any one of clauses 1 to 25 and a second communication apparatus configured to perform the method according to any one of clauses 26 to 50.

58. A computer-readable storage medium having instructions stored thereon which, when executed by one or more processors, cause the one or more processors to perform the method according to any one of clauses 1 to 25 or 26 to 50.

59. A computer program product storing instructions which, when executed by one or more processors, cause the one or more processors to perform the method according to any one of clauses 1 to 25 or 26 to 50.

60. A computer program storing instructions which, when executed by one or more processors, cause the one or more processors to perform the method according to any one of clauses 1 to 25 or 26 to 50.

In some aspects of the present disclosure, there is provided a wireless communication apparatus including processing circuitry for executing any of the above methods. It should be understood that the apparatus can execute the steps in the above method embodiments, which will not be repeated here.

In some aspects of the present disclosure, there is provided a chip, including an input/output (I/O) interface and a processor, where the processor is configured to call and run computer execution instructions stored in a memory, to enable a device installing with the chip to execute any of the above methods.

In some aspects of the present disclosure, there is provided a computer-readable medium storing computer execution instructions which, when executed by a processor, cause the processor to execute any of the above methods.

In some aspects of the present disclosure, there is provided a computer program product including computer execution instructions which, when executed by a processor, cause the processor to execute any of the above methods.

In some aspects of the present disclosure, there is provided a computer program including computer execution instructions which, when executed by a processor, cause the processor to execute any of the above methods.

Although the present disclosure describes methods and processes with steps in a certain order, one or more steps of the methods and processes may be omitted or altered as appropriate. One or more steps may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may include a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

Although embodiments have been described above with reference to the accompanying drawings, those of skill in the art will appreciate that variations and modifications may be made without departing from the scope thereof as defined by the appended claims.

What is claimed:

1. A method, comprising:
transmitting a wireless packet, wherein the wireless packet comprises a physical layer (PHY) header and a payload portion, wherein the payload portion comprises multiple constituent physical service data units (PSDUs), wherein each of the multiple constituent PSDUs comprises a PSDU, and wherein a control portion for the PSDU is used for reception and decoding of the PSDU.

2. The method according to claim 1, wherein the PHY header indicates that the payload portion comprises the multiple constituent PSDUs.

3. The method according to claim 2, wherein the PHY header comprises a universal-signal (U-SIG) field indicating that the payload portion comprises the multiple constituent PSDUs.

4. The method according to claim 1, wherein a control portion in a leading constituent PSDU of the multiple constituent PSDUs indicates that the payload portion comprises the multiple constituent PSDUs.

5. The method according to claim 1, wherein a control portion in each of the multiple constituent PSDUs comprises a signal (SIG) field indicating whether the constituent PSDU is a last constituent PSDU of the payload portion.

6. The method according to claim 1, wherein for each of the multiple constituent PSDUs, the control portion in the constituent PSDU comprises receiver information indicating a destination of the PSDU in the constituent PSDU and decoding information for decoding the PSDU in the constituent PSDU.

7. The method according to claim 6, wherein for each of the multiple constituent PSDUs, the decoding information comprises a frame check sequence (FCS) for verifying decoding of the PSDU.

8. The method according to claim 7, wherein for a leading constituent PSDU of the multiple constituent PSDUs, the decoding information of the control portion in the leading constituent PSDU comprises:
auto gain control (AGC) information for a PSDU in the leading constituent PSDU;
channel estimation information used for decoding the PSDU in the leading constituent PSDU; and
at least one signal parameter for decoding the PSDU in the leading constituent PSDU.

9. The method according to claim 8, wherein the control portion in the leading constituent PSDU comprises a short training field (STF) indicating the AGC information for the PSDU in the leading constituent PSDU.

10. The method according to claim 8, wherein the control portion in the leading constituent PSDU comprises a long training field (LTF) indicating the channel estimation information for the PSDU in the leading constituent PSDU.

11. The method according to claim 8, wherein the control portion in the leading constituent PSDU comprises a SIG field indicating the at least one signal parameter for decoding the PSDU in the leading constituent PSDU.

12. The method according to claim 11, wherein the at least one signal parameter for decoding the PSDU in the leading constituent PSDU comprises at least one of:
a resource unit (RU) allocation of the PSDU in the leading constituent PSDU;
a modulation and coding scheme (MCS) of the PSDU in the leading constituent PSDU; or
a number of spatial streams for the PSDU in the leading constituent PSDU.

13. The method according to claim 8, wherein for each of at least one constituent PSDU among the multiple constituent PSDUs other than the leading constituent PSDU, the decoding information of the control portion in the constituent PSDU comprises at least one of:
AGC information for a PSDU in the constituent PSDU;
channel estimation information used for decoding the PSDU in the constituent PSDU; or
at least one signal parameter for decoding the PSDU in the constituent PSDU.

14. The method according to claim 13, wherein the control portion in the constituent PSDU comprises an STF indicating the AGC information for the PSDU in the constituent PSDU.

15. The method according to claim 13, wherein the control portion in the constituent PSDU comprises a LTF indicating the channel estimation information for the PSDU in the constituent PSDU.

16. The method according to claim 13, wherein the control portion in the constituent PSDU comprises a SIG field indicating the at least one signal parameter for decoding the PSDU in the constituent PSDU.

17. The method according to claim 13, wherein the at least one signal parameter for decoding the PSDU in the constituent PSDU comprises at least one of:
an RU allocation for the PSDU in the constituent PSDU;
an MCS for the PSDU in the constituent PSDU; or
a number of spatial streams for the PSDU in the constituent PSDU.

18. The method according to claim 1, wherein the PHY header indicates at least one of:
a number of constituent PSDUs in aggregation of multiple PPDUs (A-PPDU);
a length of each of the multiple constituent PSDUs in the A-PPDU; or
a length of the control portion for each PSDU in the A-PPDU.

19. A method, comprising:
receiving a wireless packet, wherein the wireless packet comprises a physical layer (PHY) header and a payload portion, wherein the payload portion comprises multiple constituent physical service data units (PSDUs), wherein each of the multiple constituent PSDUs comprises a PSDU, and wherein a control portion for the PSDU is used for reception and decoding of the PSDU.

20. A wireless communication apparatus, comprising:
one or more processors; and
a memory storing instructions which, when executed by the one or more processors, cause the wireless communication apparatus to:
transmit a wireless packet, wherein the wireless packet comprises a physical layer (PHY) header and a payload portion, wherein the payload portion comprises multiple constituent physical service data units (PSDUs), wherein each of the multiple constituent PSDUs comprises a PSDU, and wherein a control portion for the PSDU is used for reception and decoding of the PSDU.
